(19) United States
(12) Patent Application Publication
(10) Pub. No.: US 2018/0032679 A1
(43) Pub. Date: Feb. 1, 2018

(54) MEDICAL RECORDING SYSTEM

(71) Applicant: INTERNATIONAL BUSINESS MACHINES CORPORATION, Armonk, NY (US)

(72) Inventors: Bharath Dandala, White Plains, NY (US); Murthy V. Devarakonda, Peekskill, NY (US); Christopher Nielson, Reno, NV (US)

(21) Appl. No.: 15/223,687

(22) Filed: Jul. 29, 2016

(51) Int. Cl. G06F 19/00; G06F 3/0482; G06F 17/30

(52) U.S. Cl. CPC G06F 19/322; G06F 19/3406; G06F 17/3053; G06F 19/3475; G06F 3/0482

(57) ABSTRACT

Technical solutions are described for automatically displaying related medical entities in an electronic medical record system. An example computer-implemented method includes displaying, via a user interface, a first list of first medical entities and a second list of second medical entities. The computer-implemented method also includes receiving a selection of a first medical entity via the user interface. The computer-implemented method also includes identifying one or more second medical entities that are related to the first medical entity. The computer-implemented method also includes in response to receiving the selection, highlighting the one or more second medical entities displayed via the user interface.

### BACKGROUND

The present application relates to electronic medical records, and more specifically, to scoring relations between medical entities in the electronic medical records using practice-based associations.

The use of electronic medical records (EMRs) allows for the retention of a person's entire medical history. While retaining this information is important, the unintended result is that the EMRs contain a large amount of documents and information, which can be difficult to ingest and analyze. Thus, the retention of entire patient's history in the form of EMRs has generated a technical problem, which needs technical solutions, to facilitate medical professionals to understand the patient's medical history, such as when the patient approaches for additional medical diagnosis or treatment.

### SUMMARY

According to one or more embodiments, a system for automatically displaying related entities in an electronic medical record includes a user interface device. The system also includes a memory, and a processor coupled with the user interface and the memory. The processor receives a selection of a medical problem via the user interface. The processor also identifies one or more medications related to the medical problem. The processor also, in response to receiving the selection, highlights the related one or more medications displayed via the user interface.

According to one or more embodiments, a computer program product for automatically displaying related medical entities in an electronic medical record includes a computer readable storage medium. The computer readable storage medium includes computer executable instructions to receive a selection of a first medical entity via a user interface. The computer readable storage medium also includes instructions to identify one or more second medical entities related to the first medical entity. The computer readable storage medium also includes instructions to, in response to receiving the selection, highlight the one or more second medical entities displayed via the user interface.

According to one or more embodiments, a computer-implemented method for automatically displaying related medical entities in an electronic medical record system, includes displaying, via a user interface, a first list of first medical entities and a second list of second medical entities. The computer-implemented method also includes receiving a selection of a first medical entity via the user interface. The computer-implemented method also includes identifying one or more second medical entities that are related to the first medical entity. The computer-implemented method also includes in response to receiving the selection, highlighting the one or more second medical entities displayed via the user interface.

Additional features and advantages are realized through the techniques of the present disclosure. Other embodiments and aspects of the disclosure are described in detail herein. For a better understanding of the disclosure with the advantages and the features, refer to the description and to the drawings.

### BRIEF DESCRIPTION OF THE DRAWINGS

The examples described throughout the present document may be better understood with reference to the following drawings and description. The components in the figures are not necessarily to scale. Moreover, in the figures, like-referenced numerals designate corresponding parts throughout the different views.

FIG. 1 illustrates a block diagram for performing lexical semantic analysis (LSA) to identify relationships between pairs of terms in an electronic medical record in accordance with one or more embodiments.

FIG. 2 illustrates a block diagram of a dataflow of a feature generator in accordance with one or more embodiments.

FIG. 3 illustrates an example of additional relations that can be found between simvastatin and hyperlipidemia by performing DRD in accordance with one or more embodiments.

FIG. 4 illustrates an example EMR analysis system in accordance with one or more embodiments.

FIG. 5 illustrates an example user interface that an EMR analysis system provides in accordance with one or more embodiments.

FIG. 6 illustrates a flowchart of an example method for displaying related entities in accordance with one or more embodiments.

FIG. 7 illustrates example components of the EMR analysis system in accordance with one or more embodiments.

FIG. 8 illustrates a flowchart of an example method for computing the entity-relation-score between a pair of the medical entities from the patient EMR in accordance with one or more embodiments.

FIG. 9 illustrates an example scenario for mapping a medication name to multiple (potential) standard codes using UMLS relations in accordance with one or more embodiments.

FIG. 10 illustrates an example scenario in which the input pair (P, M) in which P is a disease term ‘Anemia’ and M is a medication Flucanazole in accordance with one or more embodiments.

FIG. 11 illustrates an example timeline view of the patient EMR in accordance with one or more embodiments.

### DETAILED DESCRIPTION

As used herein, the terms “entity” and “term” are used interchangeably to refer to any meaningful linguistic expression that identifies an object of interest in the target domain. As used herein, the term “semantic relation” or “relation” refers to an association that exists between the meanings of two entities. A semantic relation can hold between two entities if they participate in a specific frame (e.g., medication prescribed for disease). Embodiments described herein can identify semantic relations and can use pre-existing semantic relations between entities as features for the machine learning algorithms described herein.

Disclosed here are technical solutions for facilitating deciphering a patient's medical history, such as when the patient approaches for additional medical diagnosis or treatment. Example embodiments of the disclosure include or yield various technical features, technical effects, and/or improvements to technology. For instance, example embodiments of the disclosure provide the technical effect of automatic identification of relationships between two medical entities, such as the diagnoses of a patient and the medications, lab tests, or procedures the patient has been prescribed or undergone by analyzing the electronic medical records of the patient. By identifying the relationships accurately, the technical effects further include cognitive applications involving medical text and patient records, for example, in question answering on medical corpus and in summarizing patient medical records.

The technical solutions described herein include additional technical features of quantifying strength of the relationship between the two medical entities, such as the relationship between a diagnosed disease and a medication, a lab test, or a diagnostic procedure. By accurately determining the strength of the relationship of the medical entities in an EMR, the technical solutions facilitate users of the EMR, such as physicians, nurses, and other care providers to understand diagnostics and treatments for disease or medical problem with which a patient is diagnosed. Further, the medical care providers can identify such critical information without spending large amounts of time going through the details of a patient's record, which can be 1000's of clinical notes and may amount to several megabytes. An EMR does not store or record the relationships, and therefore analytics are needed to determine the relationships.

Further, the technical effects include notifying a user, via a user-interface, of pairs of related medical entities, such as <disease, medication>, or <disease, laboratory procedure>, from the patient medical history. The notifications facilitate the user, such as a medical professional, to understand the patient medical history faster and further improves the medical services provided to the patient. The technical solutions described herein are rooted in and/or tied to computer technology in order to overcome a problem specifically arising in the realm of computers, specifically deciphering, and analyzing electronic medical records (EMRs).

The technical solutions described herein further improve the available technical solutions for analyzing EMRs. Typically, automated mechanisms for establishing relationships between medical entities have been knowledge based. In other words, typical automated EMR analysis includes extracting relationships between medical entities from medical guidelines or medication treatment knowledge bases. However, one of the drawbacks of such techniques is that it can be difficult to both assemble and derive the strengths of relationships from knowledge bases and guidelines. Further, another disadvantage of the existing method is that diagnostic and treatments methods used in practice may differ from the medical literature. For example, a medication approved for a disease may not be prescribed in practice and a medication approved for one disease may be used for another disease (“off-label” use). The technical solutions described herein provide technical features that improve the EMR analysis systems to identify the relationships between medical entities that are included in the patient medical history by developing a relation-scoring system based on practice-based temporal diagnostic and treatment data. The relation-scoring system uses practice-based temporal diagnostic and treatment data from a training dataset, which includes a large number (e.g. tens of millions) of actual patient records to develop a set of association scores between pair-wise entities such as diagnosed diseases and medications prescribed. The relation-scoring system uses the association scores to train a machine-learning model. The relation-scoring system uses the trained model for determining the strength and categorization of a relationship between an unseen pair of diagnosed disease and medication prescribed in the patient's medical history. Accordingly, the technical solutions described herein overcome the technical problems with the existing EMR analysis techniques based on medical literature, and thus improve the existing EMR analysis techniques.

The technical solutions further improve the EMR analysis systems that are currently available by reflecting the medical practice and physicians' judgement from the existing medical records, rather than the conceptual text book knowledge; reflecting changes in practice over time (i.e. latest-ness of the relationship); improving accuracy of the EMR analysis by deriving features from the structural data entered into an electronic medical record, and as such eliminating or reducing the noise (inaccuracies) in text processing. As a result of these technical features and technical effects, an EMR analysis system in accordance with example embodiments of the disclosure represents an improvement to existing EMR analysis techniques, particularly identifying relationships between entities in a patient's EMR. It should be appreciated that the above examples of technical features, technical effects, and improvements to technology of example embodiments of the disclosure are merely illustrative and not exhaustive.

The technical solutions described herein further have technical effects of creating a patient record summary from electronic medical records of a patient. Because EMRs are widely adopted in patient care, the patient record data stored in electronic form has grown exponentially. A typical EMR contains several hundreds of unstructured plain text clinical notes, as well as large amounts of semi-structured data, such as medications ordered, lab test values, medical/diagnostic procedures, and vitals. The electronic and computer technology that facilitates digitally recording every aspect of patient care is making it difficult to comprehend the patient record quickly, creating a cognitive overload. The one or more examples described herein address such a technical challenge by automated generation of patient record summary.

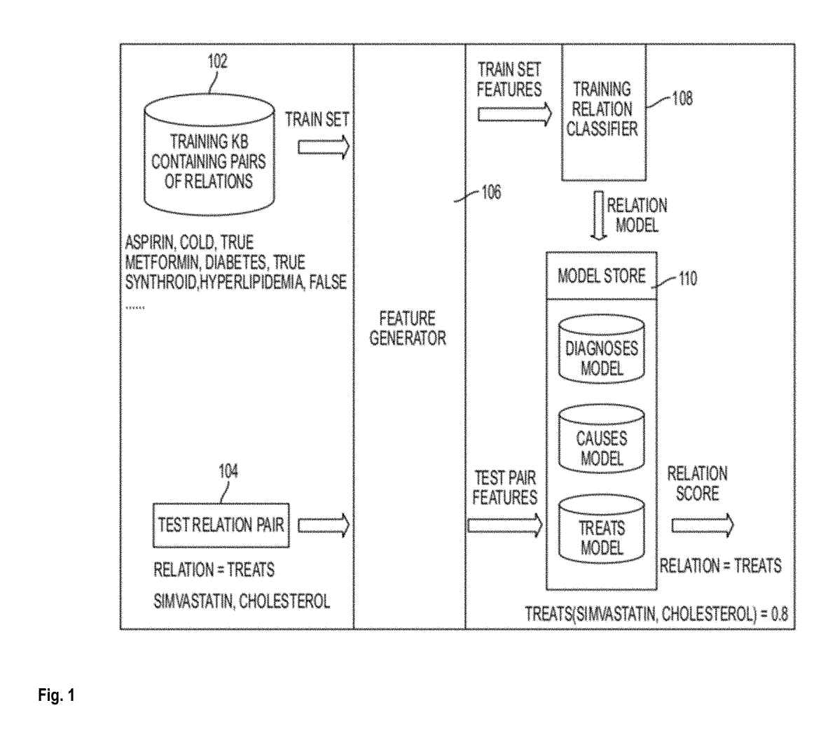

FIG. 1 illustrates a block diagram for performing lexical semantic analysis (LSA) to identify relationships between pairs of terms in EMRs. The illustrated example shows LSA being performed using distributional relation detection (DRD), however it is understood that LSA may be performed using any other technique such as latent dirichlet association (LDA), independent component analysis (ICA), probabilistic LSA (PLSA), or the like or a combination thereof. DRD is one of several techniques that may be used to detect semantic relations between terms in a corpus that occur within a sentence, across sentences (i.e., in two or more sentences) and across documents (i.e., in two or more documents). DRD can take into consideration the distributional properties of candidate pairs of terms and use those distributional properties as features to train a relation extraction algorithm. DRD can be trained by listing pairs of seed terms related by any given relation, and its coverage expanded to pairs of terms that never occurred together in the same document, thus allowing a substantial increase in coverage when compared to traditional relation extraction techniques. In addition, embodiments can be used to simplify relation extraction training procedures by avoiding the requirement of hand tagged training data showing the actual text fragment where the relation occurs. Thus, relation annotation is not required on documents, and the domain expert doing the annotating does not need to be skilled in natural language processing (NLP).

Further, embodiments of DRD described herein can detect relations between entities across documents and thus, the use of DRD can result in a significantly increased coverage when compared to some of the other LSA techniques. An embodiment of the DRD model is based on the distributional hypothesis, which suggests that semantically similar terms tend to occur in similar linguistic contexts. DRD can be used to find evidence from the contexts where entities have been found across a large corpus (e.g., a set of documents that can include unstructured text) and can use distributional similarity techniques to find similar information considering variants of the entities. Embodiments described herein can be used to train supervised classifiers for each relation using features derived from unsupervised learning. For each relation, the training set can be composed of argument pairs for both positive and negative examples. In embodiments, the argument pairs are not limited to those found together in the same sentence or even the same document.

For example, a supervised learning technique of the DRD utilizes a training step. The supervised learning can include a training data set that contains positive and negative examples of pairs of terms annotated with a given set of relations (e.g. diagnoses, causes, treats). Features describing the pairs of entities can be obtained using data in an ontology and distributional semantics (DS). The training knowledgebase (KB) 102 shown in FIG. 1 contains entity pairs of relations and a binary assessment of whether the entities are related by the relation (“true”) or are not related (“false”). An example “Treats” relation training set shown in FIG. 1 includes: Aspirin, Cold, true; Metformin, Diabetes, true; and “Synthroid, Hyperlipidemia, false. During the training phase, a model can be built for each of the given relations. The training phase can include inputting a training set from the training KB 102 into a feature generator 106, which outputs training set features. The training set features are then input to a training relation classifier 108, which creates one or more relation classifier models (e.g., one relation classifier model for each relation in the domain) that are stored in the model store 110. In one or more examples, there is a different training relation classifier 108 for each of the relations in the domain. Alternatively, or in addition, two or more relations in the domain share a training relation classifier 108. The model store 110 shown in FIG. 1 includes a separate relation classifier model for each relation (e.g., diagnoses, causes, and treats).

After the training phase is completed, the system can be used for relation detection by applying the desired relation classifier model in the model store 110 to a new pair of entities (e.g., a pair of terms). As shown in FIG. 1, the test relation pair 104 is input to the feature generator 106, which outputs test pair features. The test pair features are then input to the model store 110, which outputs a relation score that can indicate the probability that a particular semantic relation applies for the input terms. In the example shown in FIG. 1, the test pair of terms is Simvastatin, Cholesterol and the relation score produced by the system for the “Treats” relation is 0.8. This indicates that there is an 80% chance that Simvastatin treats Cholesterol.

The training relation classifier 108 is used only in the training phase. The training relation classifier 108 can use the relation examples in the training KB 102 together with the features that are generated by the feature generator 106 to train a logistic classifier model, or relation classifier model, for each relation of interest in the domain. In an embodiment, a relation classifier model is trained for each relation to be detected using, for example, a linear regression classifier. For each relation, both positive and negative examples are utilized, with each example having a set of features. Once the training relation classifier 108 trains the relation classifier models and the corresponding relation classifier models are stored in the model store 110, a new pair of terms, referred to as the test relation pair 104, can be input to the feature generator 106. The feature generator 106 generates test pair features, which are then input to a relation classifier model in model store 110. The relation classifier model classifies the relation and outputs a score predicting the existence of a particular relation (e.g., selected from a relation corresponding to one of the relation classifier models) between the terms in the test relation pair 104. As described herein, the model store 110 can contain relation classifier models for each relation, be populated during the training phase by the training relation classifier 108, and be used at test/run-time for detecting relations between argument pairs

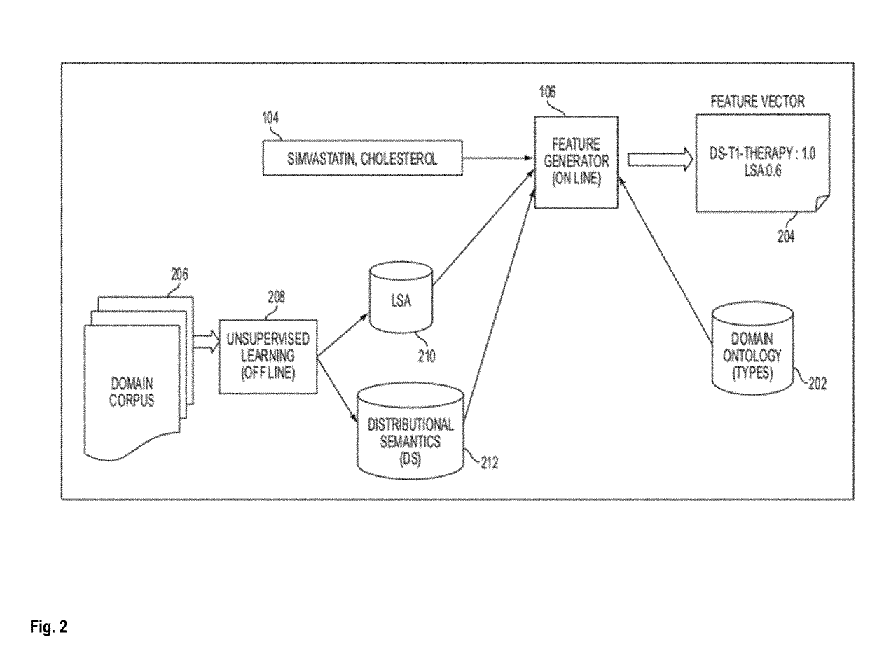

The feature generator 106 can be used to extract features that describe pairs of entities based on information learned from text (such as that stored in the LSA database 210 and the DS database 212 shown in FIG. 2) and information stored in a domain ontology 202 (such as the Unified Medical Language System or “UMLS” for the medical domain). The feature generator 106 shown in FIG. 1 can be used during all of the training, test, and run-time phases to create features which describe pairs of entities. As used herein, the term “training phase” refers to applying the algorithms needed for building the relation classifier models and the terms “test phase” and “run-time phase” refer to applying the learned relation classifier models built during the training phase to new data. During the training phase, the feature generator 106 can produce sets of features for all or a subset of the entity pairs of relations in the training KB 102. This is contrasted with the test phase, where the feature generator 106 can produce features for entities in a test relation pair 104.

Turning now to FIG. 2, a block diagram of a dataflow of the feature generator 106 is generally shown in accordance with one or more embodiments. The dataflow shown in FIG. 2 facilitates extracting features that describe a pair of entities (or terms) that are input to the feature generator 106. As shown in FIG. 2, a corpus containing content related to a particular domain, or a domain corpus 206, is used as input to an unsupervised learning process 208, which can be performed in an offline mode. As used herein, the term “offline mode” refers to processing that generally only happens only one time and as input to another phase. In an embodiment, the results of the unsupervised learning process 208 are available before starting the training phase and used as input to the training phase.

In an embodiment, the unsupervised learning process 208 includes performing DS to determine entity types and semantic contexts containing both entities. Features that include argument types can be derived from text (e.g., from the domain corpus 206) using DS. Syntactic connections can also be made between arguments in the corpus, these can often include connections that are of high precision and low recall (e.g., explicit mention of the relations found in text (Simvastatin treats hyperlipidemia), dependencies such as nnModification_modifiernoun).

Syntactic connections between terms similar to the arguments in the domain corpus 206 can also be derived, and these can often include connections that are of high recall and low precision. For example, given the two terms simvastatin and hyperlipidemia, types can be derived from domain corpus 206 by applying “is a” patterns that can be assigned to each type. This can result in simvastatin having types of medication, treatment, inhibitor, therapy, agent, dose, and drug. In one or more examples, a reliability indicator can also be associated with each time. Applying “is a” patterns to the term hyperlipidemia can result, for example, in the types of cause, disorder, condition, diabetes, syndrome, resistance, risk factor, factor, disease, and symptom. These types can be stored in the DS database 212.

The unsupervised learning 208 can also detect relations in the domain corpus 206 that are not found in the same document. For example, suppose that in the domain corpus 206 no connection is found between the terms simvastatin and hyperlipidemia, that is, these terms are not found in the same sentence or document. This lack of connection can be due to the sparsity of terms in the domain corpus 206. For example, one or both of these terms is not found in the domain corpus.

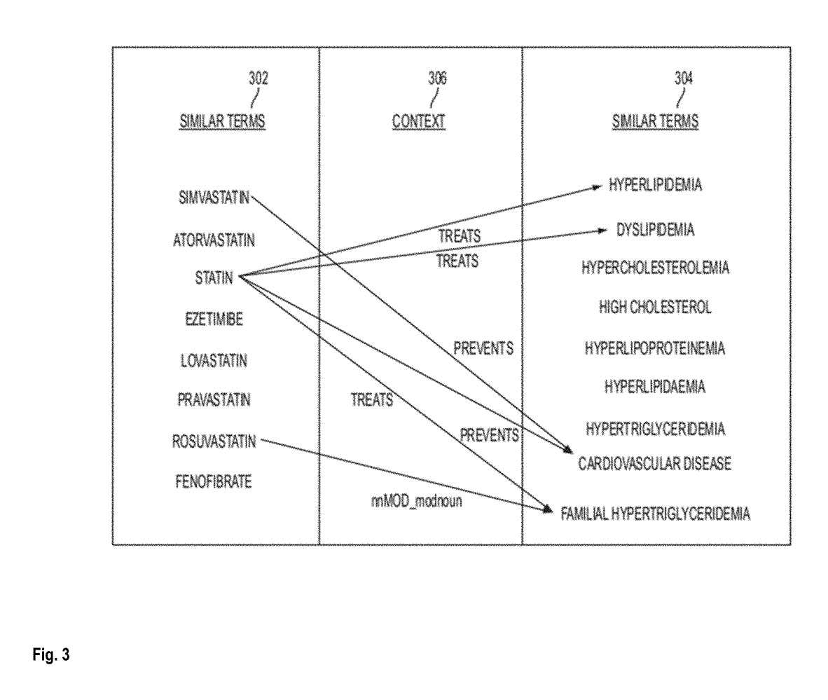

FIG. 3 illustrates an example of additional relations that can be found between simvastatin and hyperlipidemia by performing DRD in accordance with one or more embodiments. As shown in FIG. 3, a determination can be made that simvastatin is semantically similar (similar terms 302) to atorvastatin, statin, ezetimibe, lovastatin, pravastatin, rosuvastatin, and fenofibrate. In addition, it can be determined that hyperlipidemia is semantically similar (similar terms 304) to dyslipidemia, hypercholesterolemia, high cholesterol, hyperlipoproteinemia, hyperlipidaemia, hypertriglyceridemia, cardiovascular disease, and familial hypertriglyceridemia. In one or more examples, a framework such as JOBIM TEXT™ may be used to acquire the semantically similar terms. It is understood that any other corpus based or dictionary based technique to assess substitutability between terms can be used to acquire similar terms, other than JOBIM TEXT™. Connections between these similar terms in common contexts can be used to detect relations (context 306) between simvastatin and hyperlipidemia. In an embodiment, the DS term contexts can include the paths between terms. The similar terms are used as arguments to improve relation coverage. For example, since statin treats hyperlipidemia and because statin is similar to simvastatin, then it can be determined, using DRD, that simvastatin treats hyperlipidemia. In this manner, the treat relation is detected through the common context of similar terms.

In the example scenario shown in the FIG. 3, the “treats” relation between simvastatin and hyperlipidemia can be given a weight of three since there are three connections between similar terms in the context of treat: statin and hyperlipidemia; statin and dyslipidemia; and statin and familial hypertriglyceridemia. Further, the “prevents” relation can be given a weight of two since there are two connections between similar terms in the context of prevents: simvastatin and cardiovascular disease; and statin and familial hypertriglyceridemia. Finally, as shown in FIG. 3, the “nnMod-modnoun” relation can be given a weight of one since there is one connection between similar terms in the context of nnMod-modnoun: rosuvastatin and familial hypertriglyceridemia.

In an embodiment, only a threshold number of relevant similar terms are considered for the additional relational detection shown in FIG. 3. This threshold can reflect a measurement of similarity (e.g., a likelihood) between a term and a candidate similar term.

Referring back to FIG. 2, additional features can include those that are derived using LSA which can be performed to determine a similarity between the terms. In an embodiment, a candidate answer and question term are similar if they co-occur in similar documents.

Both the LSA database 210 and the DS database 212, as well as a domain ontology 202 can be used as input to the feature generator 106 to generate a feature vector 204. Two examples of the feature vector 204 are shown in FIG. 1, the feature vector 204 is labeled in FIG. 1 as “train set features” (shown being input to the training relation classifier) and it as “test pair features” (shown being input to the model store 110). For example, the domain ontology 202 can be the Unified Medical Language System (UMLS), which can be used by the feature generator 106 to extract semantics types and groups.

A domain ontology 202, such as the UMLS, can have different granularity of types: a fine granularity, a medium granularity, and a coarse granularity. For an example entity pair that includes simvastatin and hyperlipidemia, where the UMLS is used as the domain ontology 202, a fine granularity of a type can include the medical subject heading (MSH) taxonomy. An example of a fine granularity type for this entity pair is the “is a” relation for each argument, which will become features, resulting in types that indicate, for example, that cholesterol inhibitors (coded as C0003277 in UMLS) are a super type of simvastatin and that dyslipidemias (coded as CO242339 in UMLS) are a super type of hyperlipidemia. An example of a medium granularity type derived from the UMLS is a semantic type, such as simvastatin is a pharmacological substance (coded in UMLS as T121) and hyperlipidemia is a disease or syndrome (code in UMLS as T047). An example of a coarse granularity type derived from the UMLS is a semantic group, such as simvastatin is a chemical (coded in UMLS as CHEM) and hyperlipidemia is a disorder (coded in UMLS as DISO). In this example, only a single type is extracted from the UMLS for each entity, however embodiments support multiple codes being extracted for each entity/granularity combination. For example, simvastatin can be classified as having two or more medium granularity types including pharmacological substance (coded in UMLS as T121 and organic chemical (coded in UMLS as T109). The feature generator 106 can be used to extract features that describe pairs of entities based on information learned from text (such as that stored in the LSA database 210 and the DS database 212) and information stored in a domain ontology 202 (such as the UMLS for the medical domain).

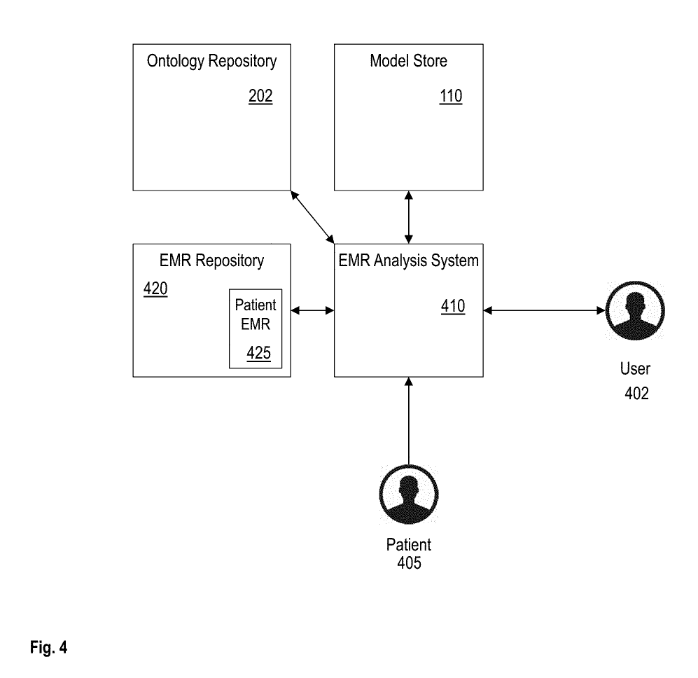

FIG. 4 illustrates an example EMR analysis system 410 that accesses the model store 110 that is populated during the training phase, as described herein. The EMR analysis system 410 further accesses the ontology repository(s) 202. The EMR analysis system 410 further accesses an EMR repository 420 that contains EMRs of multiple patients. The EMR analysis system 410 may access the other systems by communicating with the other systems in a wired or wireless manner, such as Ethernet, WIFI™, or any other or a combination thereof.

In the example scenario illustrated in FIG. 4, a user 402, such as a medical professional, may be using the EMR analysis system 410 to analyze a patient EMR 425 that is associated with a patient 405. The EMR analysis system 410 may be a point-of-care system, which facilitates the user 402 to check-in the patient 405 into a medical facility. The user 402 may determine medical history of the patient 405 for the check-in process. Alternatively or in addition, the user 402 may be using the EMR analysis system 410 to prescribe a medication, a medical procedure, or a laboratory procedure, for the patient 405. In this regard, the EMR analysis system 410 facilitates the user 402 to identify current medications that the patient 405 is taking, or recent medical/laboratory procedures that the patient 405 may have undergone.

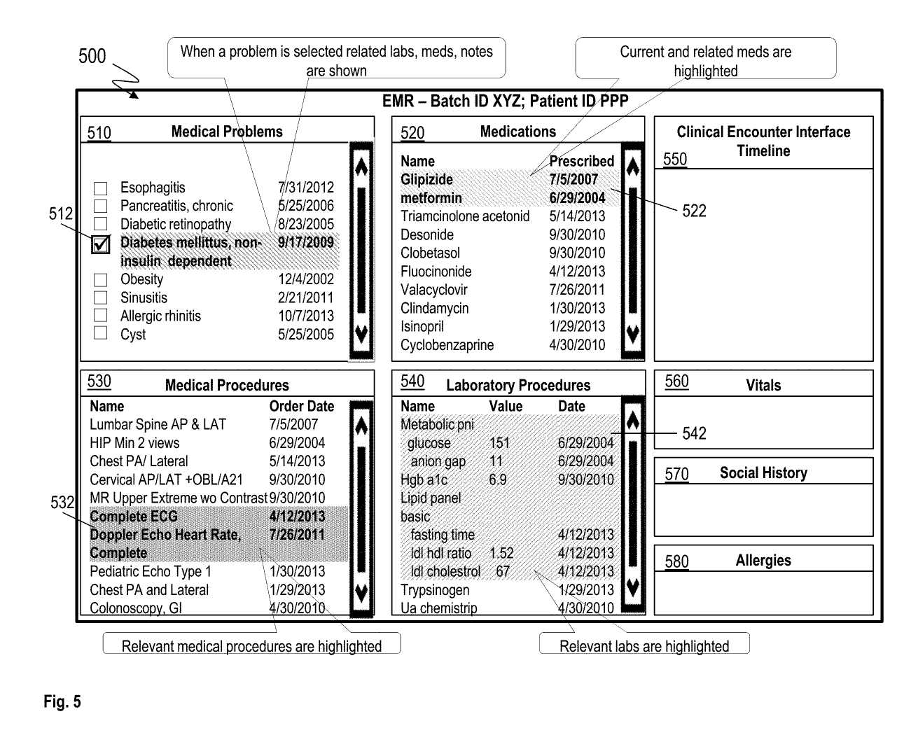

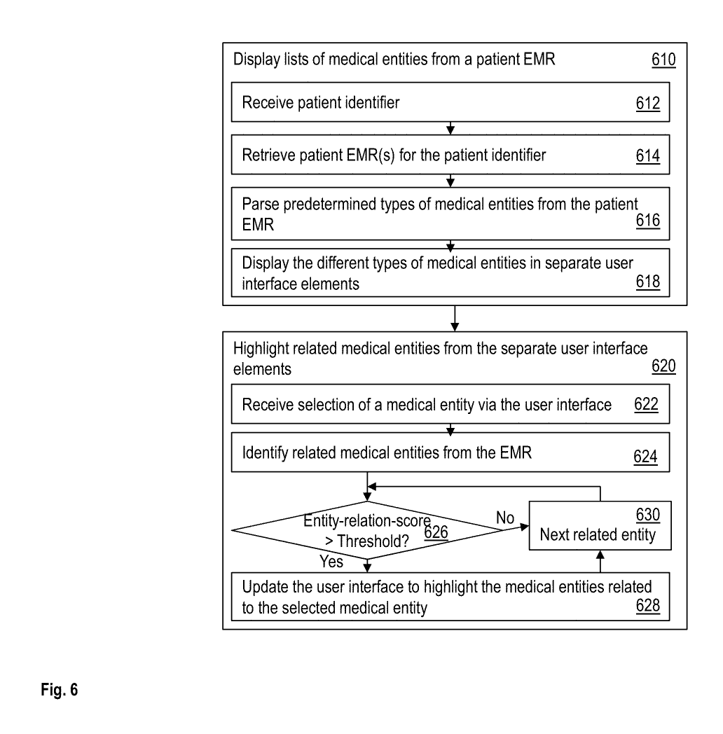

FIG. 5 illustrates an example user interface 500 that the EMR analysis system 410 provides to the user 402 to analyze the patient EMR 425. The user interface 500 displays related entities in the patient EMR 425. FIG. 6 illustrates a flowchart of an example method for displaying related entities in the EMR 425. The EMR analysis system 410 implements the method.

The EMR analysis system 410 displays lists of medical entities from the patient EMR 425, as shown at block 610. FIG. 5 illustrates example lists of medical entities such as lists of medical problems 510, medications 520, medical procedures 530, laboratory procedures 540, vitals 560, social history 570, and allergies 580. It is understood that one or more examples, may include more, fewer, or different lists of medical entities than those illustrated in FIG. 5. In one or more examples, the medical entities in the displayed lists include medical entities associated with the patient 405. For example, the medical problems 510 include the medical problems that the patient 405 has been diagnosed with. The medications 520 include the medications that the patient 405 has been prescribed (or is taking). The medical procedures 530 include the medical procedures that the patient 405 has undergone. The laboratory procedures 540 are the laboratory procedures that the patient 405 has undergone. In one or more examples, the user interface 500 lists medical entities from a repository, and not just a subset of medical entities associated with the patient EMR 425.

To display the list of medical entities from the patient EMR 425, the EMR analysis system 410 may initially receive a patient identifier, as shown at block 612. For example, the user 402 may input the patient identifier via the user interface 500. The patient identifier may be a unique identifier associated with the patient 405, a name, an address, a telephone number, or any other type of identifier of the patient 405. The EMR analysis system 410 retrieves the patient EMR 425 from the EMR repository 420 based on the patient identifier, as shown at block 614. In one or more examples, the EMR repository 420 may include more than one EMRs associated with the patient 405. For example, the EMR repository 420 may include EMRs from one or more medical providers, such as hospitals, laboratories, dentists, eye-doctors, and other types of medical service providers. The EMR analysis system 410 may retrieve the specific type of EMRs from the EMR repository 420, such as EMRs from similar type of medical service provider as the user 402.

The EMR analysis system 410 parses the retrieved patient EMR 425 to identify the predetermined medical entities to be displayed via the user interface 500, as shown at block 616. For example, the patient EMR 425 may be a structured record that contains the information in a predetermined format, facilitating the EMR analysis system 410 to retrieve the medical entities to be displayed by generating queries based on the patient EMR 425. In one or more examples, if the patient EMR 425 is not maintained according to a predefined structure, the EMR analysis system 410 may use NLP techniques to identify the medical entities from the patient EMR 425.

The EMR analysis system 410 further displays the medical entities in separate user interface elements as illustrated in FIG. 5, and as shown at block 618. The user interfaces may be list-boxes, combo-boxes, text-boxes, or any other types of user interface elements or a combination thereof. The user interface elements facilitate the user 402 to select, and/or edit the medical entities from the displayed lists of medical entities. In one or more examples, the user interface 500 may limit the selection from a subset of the medical entities displayed. For example, the user interface 500 may only facilitate selection of one or more medical problems, and not facilitate selection of medical entities from the other lists, such as the medications, the laboratory procedures, the medical procedures, and others. The user interface 500 may also display timestamps, such as a date, a time, or the like when a particular medical entity was associated with the patient EMR 425. For example, the list of medical problems 510 may display dates when the patient 405 was diagnosed with the respective medical problems from the patient EMR 425. The user interface 500 further displays dates or times when the other medical entities were identified, performed, or the like in case of the patient 405. The user interface 500 may also display values of the one or more laboratory procedures 540.

The EMR analysis system 410 highlights related medical entities from the separate user interface elements in response to selection of one or more medical entities via the user interface, as shown at block 620. Highlighting the related medical entities includes receiving the selection of a medical entity via the user interface 500, as shown at block 622. The EMR analysis system 410 identifies the medical entities from the patient EMR 425 that are related to the selected medical entity(s), and updates the user interface 500 to display the related medical entities in a highlighted manner, as shown at blocks 624 and 628. In one or more examples, the EMR analysis system 410 may compare an entity-relation-score between the medical entities identified as related with a predetermined threshold, as shown at block 626. If the entity-relation-score crosses the predetermined threshold, that is if the entity-relation-score is greater (or lesser) than the predetermined threshold, the EMR analysis system 410 proceeds to highlight the related medical entity, as shown at block 628. The EMR analysis system 410 does not highlight a medical entity if the entity-relation-score does not cross the predetermined threshold, and continues to check other medical entities identified as related, as shown at block 630.

In the example scenario of FIG. 5, in response to the user 402 selecting a medical problem, the EMR analysis system 410 identifies the related laboratory procedures, medications, and medical procedures, and highlights such related medical entities. For example, the user 402 may select a medical problem 512, such as a disease that the patient 405 suffers from, for example diabetes mellitus. The user 402 may select the medical problem 512 using a user interface element such as a checkbox, a radio-button, a hyperlink, or any other user interface element. In response, the EMR analysis system 410 identifies the related medication(s) 520, the related medical procedures 532, and the related laboratory procedures 542, which are related to the selected medical problem 512. The identified related medical entities are highlighted on the user interface 500 as shown.

Accordingly, the EMR analysis system 410 displays and highlights medical entities related to the selected medical problem 512 facilitating the user 402 to decipher the patient EMR 425. For example, highlighting the medications related to the selected medical problem 512 facilitates the user 402, such as a medical professional, to identify the ongoing treatment that the patient 405 is undergoing for the medical problem 512. Because the medical problem 512 may have more than one treatments, the highlighting facilitates the user 402 to identify which of the available treatments was prescribed. In other examples, the user 402 may select one or more medications from the list of medications 520, and in response, the EMR analysis system 410 highlights related entities from the list of medical problems 510, the list of medical procedures 530, and the list of laboratory procedures 540. Accordingly, the user 402 may identify the causes of the patient 405 being prescribed the selected medication. Such highlighting may facilitate the user 402 to identify that the selected medication may have been prescribed for ‘off-label’ use. It is understood that in other examples, the user 402 may select any medical entity displayed by the user interface 500 and that in response the EMR analysis system 410 identifies and highlights one or more medical entities via the user interface 500.

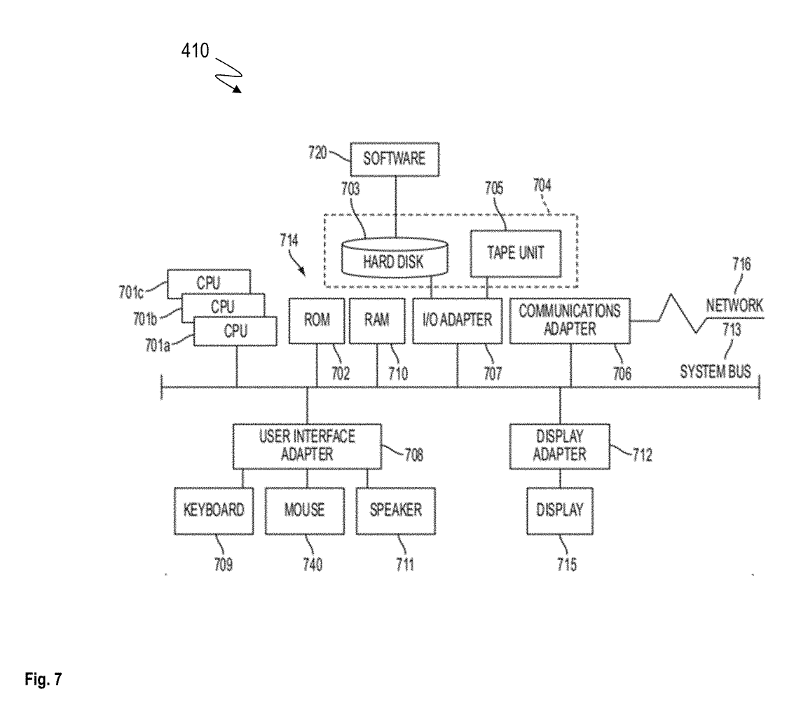

FIG. 7 illustrates example components of the EMR analysis system 410 that implements one or more of the technical solutions described herein. The EMR analysis system 410 may be hardware computing apparatus, such as a desktop computer, a server computer, a laptop computer, a tablet computer, a phone, or any other computing apparatus. The EMR analysis system 410 has one or more central processing units (processors) 701a, 701b, 701c, etc. (collectively or generically referred to as processor(s) 701). Processors 701 are coupled to system memory 714 and various other components via a system bus 713. Read only memory (ROM) 702 is coupled to system bus 713 and may include a basic input/output system (BIOS), which controls certain basic functions of the EMR analysis system 410. The system memory 714 can include ROM 702 and random access memory (RAM) 710, which is read-write memory coupled to system bus 713 for use by processors 701.

FIG. 7 further depicts an input/output (I/O) adapter 707 and a network adapter 706 coupled to the system bus 713. I/O adapter 707 may be a small computer system interface (SCSI) adapter that communicates with a hard disk 703 and/or tape storage drive 705 or any other similar component. I/O adapter 707, hard disk 703, and tape storage drive 705 are collectively referred to herein as mass storage 704. Software 720 for execution on the EMR analysis system 410 may be stored in mass storage 704. The mass storage 704 is an example of a tangible storage medium readable by the processors 701, where the software 720 is stored as instructions for execution by the processors 701 to perform the one or more methods described herein. Network adapter 706 interconnects system bus 713 with an outside network 716 enabling the EMR analysis system 410 to communicate with other such systems. A screen (e.g., a display monitor) 715 is connected to system bus 713 by display adapter 712, which may include a graphics controller to improve the performance of graphics intensive applications and a video controller. In one embodiment, adapters 707, 706, and 712 may be connected to one or more I/O buses that are connected to system bus 713 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 713 via user interface adapter 708 and display adapter 712. A keyboard 709, mouse 740, and speaker 711 can be interconnected to system bus 713 via user interface adapter 708, which may include, for example, a Super I/O chip integrating multiple device adapters into a single integrated circuit.

Thus, as configured in FIG. 7, the EMR analysis system 410 includes processing capability in the form of processors 701, and, storage capability including system memory 714 and mass storage 704, input means such as keyboard 709 and mouse 740, and output capability including speaker 711 and display 715.

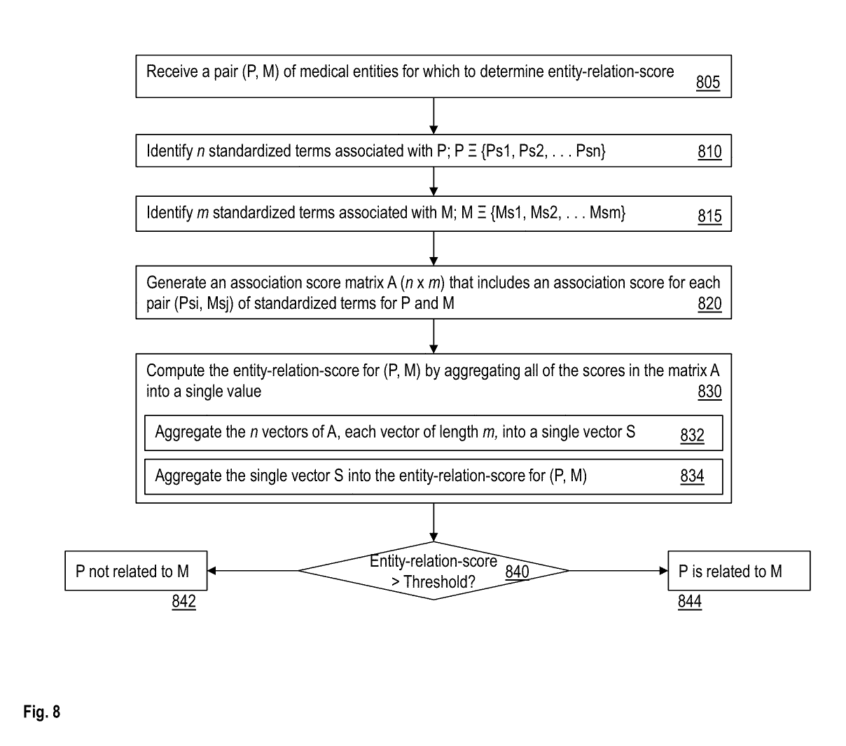

FIG. 8 illustrates a flowchart of an example method for computing the entity-relation-score between a pair of the medical entities from the patient EMR 425. The EMR analysis system 410 implements the method in one or more examples. The entity-relation-score between a pair of medical entities may be computed based on the relation scores of the one or more associations between the pair of medical entities. For example, the EMR analysis system 410 receives a pair (P, M) of medical entities for which to determine entity-relation-score, as shown at block 805. The pair (P, M) may be pair of any two medical entities, such as medical problems, medications, laboratory procedures, medical procedures, and so on. The pair of medical entities is received in form of electronic text by parsing the patient EMR 425. For example, P from the pair (P, M) may be the selected medical problem 512, and M may be any of the other medical entities of a type different from that of P. For example, if P is the selected medical problem 512, M may be a medication, a medical procedure, or a laboratory procedure.

The EMR analysis system 410 further identifies standardized terms associated with P and standardized terms associated with M, as shown at blocks 810 and 815. The EMR analysis system 410 thus standardizes the input medical entities using the ontology repositories 202, such as the common standardized coding systems such as INTERNATIONAL STATISTICAL CLASSIFICATION OF DISEASES (ICD™) SNOMED CT™ or UNIFIED MEDICAL LANGUAGE SYSTEM™ (UMLS™). The EMR analysis system 410 may determine concept unique identifier (CUI) of the medical entity from one of the standardized coding systems, and further use the CUI of the medical entity to determine additional standardized terms for the medical entity from other coding schemes. For example, the EMR analysis system 410 may use the CUI to identify other variants of the medical entity from ontology repositories for medications such as RXNORMS™, for laboratory procedures such as LOINC™, and for medical procedures, such as CPT™. Alternatively, or in addition, the EMR analysis system 410 uses one or more of the above standardizing schemes to determine the CUI of the medical entity depending on the type of the input medical entity. In each case, the input medical entities, P and M, are mapped to one or more standardized terms.

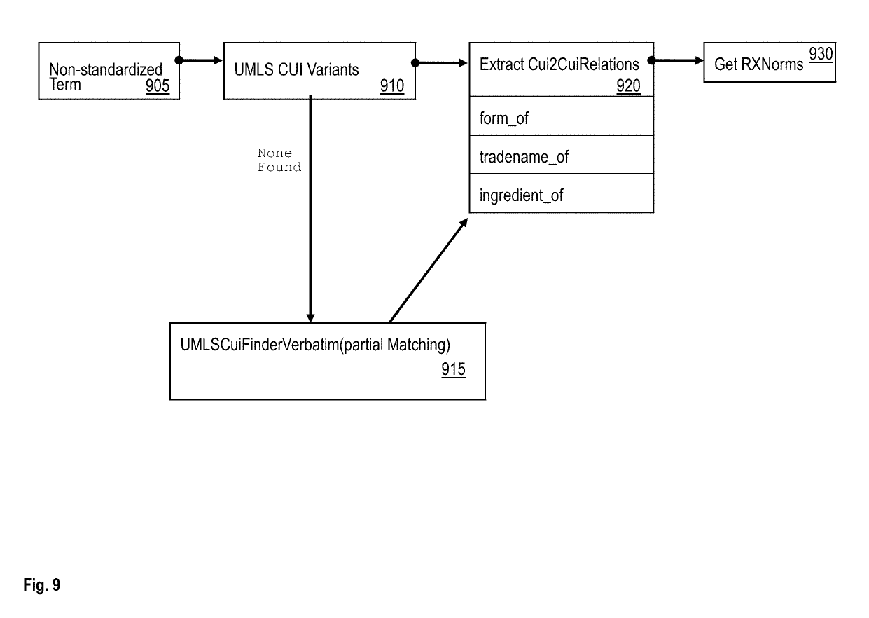

FIG. 9 illustrates an example scenario for mapping a medication name to multiple (potential) standard codes using UMLS relations. For example, if P (or M) is a medication (i.e. a medical entity) parsed from the patient EMR 425, P may be a non-standardized term, as shown at block 905. The EMR analysis system 410 determines the UMLS CUI variants for the non-standardized term, as shown at block 910. If the non-standardized term does not result in a UMLS CUI, the EMR analysis system 410 determines CUI variants from UMLS that partially match the term P, as shown at block 915. The EMR analysis system 410 further determines related CUIs in the ontology repository, that is UMLS, as shown at block 920. For example, the EMR analysis system 410 identifies if the CUI of the medication is associated with any other terms, such as different forms, different tradenames. In addition, the EMR analysis system 410 may identify if there are additional CUIs, which share the same ingredients as the medication P. Alternatively, or in addition, the EMR analysis system 410 determines CUIs, which have the medication P as an active ingredient. The EMR analysis system 410 further determines normalized names and unique identifiers for the medication (or drugs) by accessing a coding system, such as the RXNORM™ that is maintained by the National Library of Medicine (NLM) in the US, and/or other such repositories, as shown at block 930.

Thus, the EMR analysis system 410 determines all variants of the input medical entity that may be used in the patient EMR 425 and/or in the corpus of medical information in general. For example, fluconazole is an antifungal medication, which may be marked under several brand names such as Monicure, Monistat, Canesten, Diflucan, Flucoral, Fungican, Triconal, Zocon, Alfumet, Afungil, Dofil, among others. In other words, for the medical entity P that was input, the EMR analysis system 410 identifies a plurality of standardized terms, and thus maps P to a set of n standardized terms {Ps1, Ps2 . . . , Psn}, as shown at block 810. In a similar manner the EMR analysis system 410 maps the second medical entity in the pair (P, M) to a second set of m standardized terms. For example, M is mapped to {Ms1, Ms2 . . . , Msm}, as shown at block 815. Table 1 illustrates some examples of standardized terms for medical entities of different types and the coding systems used in those examples.

TABLE 1

| Clinical | | | Coding |
|---|---|---|---|
| Aggregate | Non-standard | Standardized | system |
| Disease | Fibrillation | Atrial Fibrillation | Snomed |
| | | Ventricular Fibrillation | |
| Disease | Diabetes | Diabetes mellitus | Snomed |
| | | type 2 (disorder) | |
| | | Diabetes mellitus | |
| | | type 1 (disorder) | |
| Medication | Minocin(Brand | Minocycline | RXNorm |
| | Name) | | |
| Medication | Lotrel (Combination | Amlodipine/Benazepril | RXNorm |
| | drug) | | |
| Procedure | Anesthesia for upper | Anesthesia for | CPT |
| | abdominal procedure | transabdominal repair | |
| | | of diaphragmatic | |
| | | hernia | |
| Procedure | Diagnostic Radiology | Transluminal balloon | CPT |
| | Procedures of the | angioplasty, renal or | |
| | Vascular System | other visceral artery, | |
| | | radiological | |
| | | supervision and | |
| | | interpretation | |

The EMR analysis system 410 further generates an association score matrix A that includes association scores for each pair (Psi, Msj) of the standardized terms for P and M respectively, as shown at block 820. For example, the EMR analysis system 410 populates the matrix A for each (Psi, Msj) by obtaining an association score feature vector, {a_ij_1 . . . a_ij_k}, as described herein. (For example, see feature vector 204 from FIG. 2). The EMR analysis system 410 obtains association scores (or features) for each pair of standardized entities from the previously extracted association scores for the pair from the training dataset that included a large number of actual patient records.

In one or more examples, the EMR analysis system 410 mines the training dataset to determine association scores for a set of predetermined associations. For example, the predetermined associations may include determining FreqAtDx, which determines a proportion of patients P prescribed a treatment T. For example, the association FreqAtDx may identify that 45.3% of patients with a new diagnosis of Diabetes mellitus type 2 (DM-T2) are prescribed the medication METFORMIN™ within 2 days of the diagnosis.

Additionally or alternatively, the predetermined associations scored by the EMR analysis system 410 may include RelFrqAtDx, which determines uses of treatment T for a disease D compared to other diseases. For example, the association RelFrqAtDx may identify that METFORMIN™ is prescribed for DM-T2 20 times more than its use for other diagnoses. Additionally or alternatively, the predetermined associations scored by the EMR analysis system 410 may include AfterVsBeforeDX, which determines a number of times a medication is prescribed before identification of a disease versus a number of times the medication is prescribed after the identification of the disease. For example, AfterVsBeforeDX may identify that use of METFORMIN™ is 2.6 times greater than use of it over 3 months prior to the identification of disease.

Additionally or alternatively, the predetermined associations scored by the EMR analysis system 410 may include OddsrAtDx, which determines odds ratio between using treatment T and other treatments at the identification of disease. Additionally or alternatively, the predetermined associations scored by the EMR analysis system 410 may include OddsrBfrAftrDX, which determines the odds ratio of treatment T being used for a disease D within 2 days of the disease over 3 months prior to the disease. For example, OddsrBfrAftrDX may identify that the odds ratio of METFORMIN™ being used for DM-T2 is 18.25 within 2 days of the new diagnosis and 1.9 over 3 months prior to disease. Additionally or alternatively, the predetermined associations scored by the EMR analysis system 410 may include N, which determines a total number of patients with disease D and treatment T over 3 months and before to 3 months after first diagnosis.

The EMR analysis system 410 further computes the entity-relation-score for (P, M) by aggregating all of the scores in the matrix A into a single value, which is the entity-relation-score, as shown at block 830. The EMR analysis system 410 may first aggregate the values in the n×m feature vectors of matrix A into a single vector using an aggregation method, such as decaying sum, as shown at block 832. This produces a single vector S, {a_1, a_2, . . . , a_k} for (P, M). For example, values in each respective vector of the matrix A, may be added to aggregate that vector. Alternatively, the aggregation of a vector may be performed by computing a mean, a standard deviation, a variance, or any other statistic of the values in the vector. Additionally, the aggregated value of the vector may be weighted or normalized according to a predetermined weighting scheme. In one or more examples, the EMR analysis system 410 computes a decaying sum according to

$$decay ( {a}_{0} , {a}_{1} … {a}_{n} ) = {\sum }_{i = 1}^{n} ( \frac{{a}_{i}}{{2}^{i}} )$$

where a0, a1 . . . ak are the scores of the pairs, sorted in descending order. Decaying sum computed in this manner facilitates the EMR analysis system 410 to provide improved results in cases in which a relatively fewer number of standardized terms match the input term pairs better than a matching between number of term pairs and the input term pairs.

The EMR analysis system 410 further aggregates the single vector S into a single value, which is the entity-relation-score for (P, M), as shown at block 834. In one or more examples, the EMR analysis system 410 may aggregate the single vector S using a machine-learning model, learned from ground truth in a preliminary step, to produce the single entity-relation-score for the entity pair (P, M). For example, the EMR analysis system 410 may use and train a logistic regression model to compute a probability of relation being true for given terms. For example, the EMR analysis system 410 may determine the entity-relation-score as the probability based on the coefficients of the single vector S, such as by computing

$$Pre ( relation == true ) = \frac{{e}^{{b}_{1} \cdot {X}_{i}}}{{e}^{{b}_{0} \cdot {X}_{i}} + {e}^{{b}_{1} \cdot {X}_{i}}}$$

where b0,b1, . . . bi are the list of coefficients in S.

The EMR analysis system 410 compares the entity-relation-score with a predetermined threshold, as shown at block 840. If the entity-relation-score crosses (greater than or lesser than) the threshold, the EMR analysis system 410 deems that the medical entities (P, M) are related to each other, as shown at block 844. If the entity-relation-score does not cross the threshold, the EMR analysis system 410 deems that the medical entities (P, M) are not related to each other, as shown at block 842.

In one or more examples, the threshold used to determine if P and M are related may be a first threshold different than a second threshold that the EMR analysis system 410 uses to determine whether or not to highlight the related medical entities via the user interface (in FIG. 6). For example, using the method of FIG. 8, the EMR analysis system 410 identifies a set of related medical entities, and further using the method of FIG. 6, the EMR analysis system 410 highlights only a subset of the related medical entities which have entity-relation-scores above (or below) the second predetermined threshold.

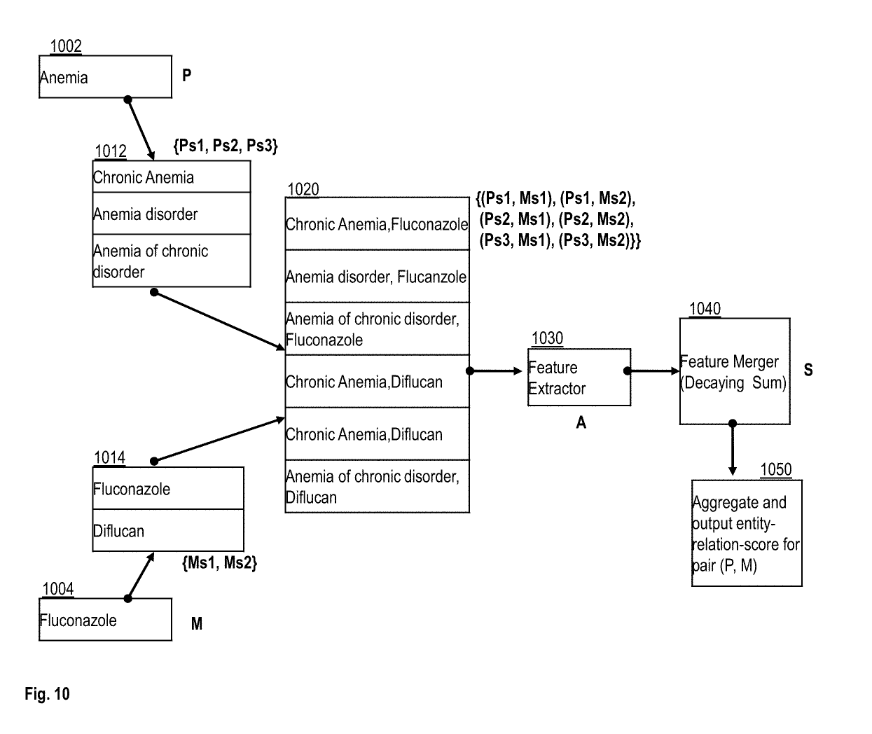

FIG. 10 illustrates an example scenario in which the input pair (P, M) in which P is a disease term ‘Anemia’ and M is a medication Fluconazole, as shown at blocks 1002 and 1004. The EMR analysis system 410 determines the standardized terms for Anemia (P) and Fluconazole (M), which results in the sets {Ps1, Ps2, Ps3} and {Ms1, Ms2} respectively, as shown at blocks 1012 and 1014. The EMR analysis system 410 further generates pairs for each of the standardized terms, which results in the six combinations, as shown at block 1020. The EMR system analysis 410 further determines the feature vectors for each pair, and populates the matrix A with n x m values, as shown at block 1030. In this example case, n is 3 and m is 2. The EMR analysis system 410 proceeds to aggregate the vectors in the matrix A to generate a single vector S using techniques such as decaying sum, as shown at block 1040. The EMR analysis system 410 aggregates the values in the vector S to compute the entity-relation-score for the pair (P, M), that is, in this case the pair (Anemia, Fluconazole), as shown at block 1050.

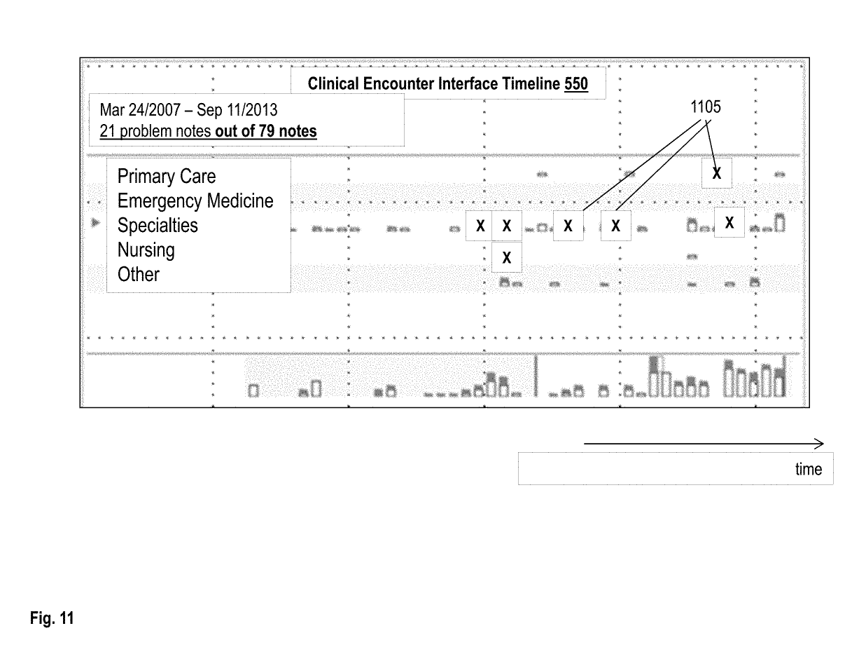

In addition, in one or more examples, the EMR analysis system 410 automatically generates a summary of the patient EMR 425. The summary may include the distinct medical problems that the patient 405 has encountered till date, or within a specified time-period. The summary may further identify the medical procedures, medications, and/or laboratory procedures prescribed in response to of each of the medical problems diagnosed. The summary may further include a timeline view of the patient EMR 425. FIG. 11 illustrates an example timeline view of the patient EMR 425. The timeline view includes a clinical encounter interface timeline 550. As illustrated in FIG. 5, the timeline view may be part of the user interface 500. The timeline 550 plots the events of the medical problem diagnosis, the medication prescriptions, the medical procedures, and the laboratory procedures along a time axis according to the occurrences of the events. In one or more examples, the timeline 550 may categorize the events according to the medical facility at which the events occurred, for example at a primary care provider facility, an emergency room, a specialty clinic/laboratory, a nursing center, or the like. It is understood that the above categorization is just one example, and that in other examples the summary may include different categorization of the events.

In addition, the EMR analysis system 410 highlights the events on the timeline that are related to the selected medical problem 512 (in FIG. 5). For example, in response to the user 402 selecting the medical problem 512, the timeline 550 may highlight (or mark) the occurrences of the events associated with the related medical entities, such as the related medication 522, the related laboratory procedure 542, the related medical procedure 532, and the like, as shown by marks 1105 in FIG. 11. The timeline 550 further facilitates the user 402 to analyze the patient EMR 425.

Accordingly, the technical solutions described herein provide technical features to improve EMR analysis system. The technical solutions facilitate identifying relationships between medical entities from EMR of a patient. The relationships are identified based on practice records including, portion of patients prescribed a treatment, use of treatment for a disease compared to other diseases, total number of times medications prescribed before the identification of disease compared to medication prescribed after the identification of disease, ratio of a treatment compared to other treatments at the identification of disease, ratio of treatment compared to other treatments over 3 months prior to the disease, total number of patients with disease and treatment over 3 months before first diagnosis, and total number of patients with disease and treatment after first diagnosis, among others.

The present technical solutions may be a system, a method, and/or a computer program product at any possible technical detail level of integration. The computer program product may include a computer readable storage medium (or media) having computer readable program instructions thereon for causing a processor to carry out aspects of the present technical solutions.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present technical solutions may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present technical solutions.

Aspects of the present technical solutions are described herein with reference to flowchart illustrations and/or block diagrams of methods, apparatus (systems), and computer program products according to embodiments of the technical solutions. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present technical solutions. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

A second action may be said to be “in response to” a first action independent of whether the second action results directly or indirectly from the first action. The second action may occur at a substantially later time than the first action and still be in response to the first action. Similarly, the second action may be said to be in response to the first action even if intervening actions take place between the first action and the second action, and even if one or more of the intervening actions directly cause the second action to be performed. For example, a second action may be in response to a first action if the first action sets a flag and a third action later initiates the second action whenever the flag is set.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are to be construed in the broadest sense, superseding any other implied definitions hereinbefore or hereinafter unless expressly asserted to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed.

It will also be appreciated that any module, unit, component, server, computer, terminal or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Such computer storage media may be part of the device or accessible or connectable thereto. Any application or module herein described may be implemented using computer readable/executable instructions that may be stored or otherwise held by such computer readable media.

The descriptions of the various embodiments of the present technical solutions have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application, or technical improvement over technologies found in the marketplace, or to enable others of ordinary skill in the art to understand the embodiments disclosed herein.

What is claimed is:

1. A system for automatically displaying related entities in an electronic medical record, the system comprising:
a user interface device;
a memory; and
a processor coupled with the user interface and the memory, and the processor configured to:
receive a selection of a medical problem via the user interface;
identify one or more medications related to the medical problem; and
in response to receiving the selection, highlight the related one or more medications displayed via the user interface.

2. The system of claim 1 wherein, the medical problem is selected from a set of medical problems associated with a patient, and the related one or more medications are highlighted in a list of medications associated with said patient.

3. The system of claim 1, wherein the one or more medications related to the medical problem are identified based on an entity-relation-score of the one or more medications being above a predetermined threshold.

4. The system of claim 3, wherein the processor is configured to compute the entity-relation-score between the medical problem and a medication by:
generating an association score matrix for the medical problem and the medication;
aggregating the association score matrix for the medical problem and the medication into a single vector of association scores; and
computing the entity-relation-score based on the single vector of association scores.

5. The system of claim 4, wherein the association score matrix comprises an association score for each pair of standardized terms from a first plurality of standardized terms and a second plurality of standardized terms, the first plurality of standardized terms being standardized terms for the medical problem, and the second plurality of standardized terms being standardized terms for the medication.

6. The system of claim 1 wherein, the processor is further configured to:
identify one or more laboratory procedures related to the medical problem; and
in response to receiving the selection of the medical problem, highlight the related one or more laboratory procedures displayed via the user interface.

7. The system of claim 1, the processor is further configured to:
identify one or more medical procedures related to the medical problem; and
in response to receiving the selection of the medical problem, highlight the related one or more medical procedures displayed via the user interface.

8. A computer program product for automatically displaying related medical entities in an electronic medical record, the computer program product comprising a computer readable storage medium, the computer readable storage medium comprising computer executable instructions, wherein the computer readable storage medium comprises instructions to:
receive a selection of a first medical entity via a user interface;
identify one or more second medical entities related to the first medical entity; and
in response to receiving the selection, highlight the one or more second medical entities displayed via the user interface.

9. The computer program product of claim 8 wherein, the first medical entity is a medical problem selected from a set of medical problems associated with a patient, and the one or more second medical entities that are highlighted comprise a subset of medications from a list of medications prescribed to said patient.

10. The computer program product of claim 8, wherein the one or more second entities are identified based on an entity-relation-score of the one or more second entities being above a predetermined threshold.

11. The computer program product of claim 10, wherein computer readable storage medium comprises instructions to compute the entity-relation-score between the first medical entity and a second medical entity from the one or more second medical entities by:
generating an association score matrix for the first medical entity and the second medical entity;
aggregating the association score matrix for the first medical entity and the second medical entity into a single vector of association scores; and
computing the entity-relation-score based on the single vector of association scores.

12. The computer program product of claim 11, wherein the association score matrix comprises an association score for each pair of standardized terms from a first plurality of standardized terms and a second plurality of standardized terms, the first plurality of standardized terms being standardized terms for the first medical entity, and the second plurality of standardized terms being standardized terms for the second medical entity.

13. The computer program product of claim 8, wherein the first medical entity is a medical problem and the one or more second medical entities are selected from the group consisting of medications, laboratory procedures, and medical procedures.

14. A computer-implemented method for automatically displaying related medical entities in an electronic medical record system, the method comprising:
displaying, via a user interface, a first list of first medical entities and a second list of second medical entities;
receiving a selection of a first medical entity via the user interface;
identifying one or more second medical entities that are related to the first medical entity; and
in response to receiving the selection, highlighting the one or more second medical entities displayed via the user interface.

15. The computer-implemented method of claim 14, wherein the first medical entity is a medical problem selected from the first list of entities that comprises a list of medical problems associated with a patient, and the one or more second medical entities that are highlighted comprise a subset of medications from the second list of entities, which is a list of medications prescribed to said patient.

16. The computer-implemented method of claim 15, wherein the one or more second medical entities includes a medication that is prescribed to the patient for off-label use.

17. The computer-implemented method of claim 14, wherein the one or more second entities are identified based on an entity-relation-score of the one or more second entities being above a predetermined threshold.

18. The computer-implemented method of claim 17, further comprising computing the entity-relation-score between the first medical entity and a second medical entity from the one or more second medical entities by:
generating an association score matrix for the first medical entity and the second medical entity;
aggregating the association score matrix for the first medical entity and the second medical entity into a single vector of association scores; and
computing the entity-relation-score based on the single vector of association scores.

19. The computer-implemented method of claim 18, wherein the association score matrix comprises an association score for each pair of standardized terms from a first plurality of standardized terms and a second plurality of standardized terms, the first plurality of standardized terms being standardized terms for the first medical entity, and the second plurality of standardized terms being standardized terms for the second medical entity.

20. The computer-implemented method of claim 14, wherein the first medical entity is a medical problem and the one or more second medical entities are selected from the group consisting of medications, laboratory procedures, and medical procedures.
